(19) United States
(12) Patent Application Publication
(10) Pub. No.: US 2023/0031194 A1
(43) Pub. Date: Feb. 2, 2023

(54) Heating Device

(71) Applicant: GENTHERM GMBH, Odelzhausen (DE)

(72) Inventor: Conan (Yan) Liu, Langfang (CN)

(21) Appl. No.: 17/785,154

(22) PCT Filed: Dec. 20, 2019
(86) PCT No.: PCT/CN2019/126905

§ 371 Date: Jun. 14, 2022

(51) Int. Cl. H05B 3/34; H05B 3/14; B60N 2/56

(52) U.S. Cl. CPC H05B 3/342; B60N 2/5678; H05B 3/145; H05B 2203/016; H05B 2203/029

(57) ABSTRACT

A heating device for a vehicle seat, the heating device includes a carrier element, and an electrically conductive thread arrangement that is fixed on the carrier element. The electrically conductive thread arrangement includes a plurality of thread sections, each of which has a plurality of thread loops. The plurality of thread sections are arranged side by side in an overlapping manner such that the plurality of thread sections cross each other several times.

### CROSS-REFERENCE TO RELATED APPLICATIONS

This application is a U.S. National Stage Entry of PCT/CN2019/126905 filed on Dec. 20, 2019.

### FIELD

The invention relates to a heating device, in particular for a vehicle seat, comprising a carrier element and an electrically conductive thread arrangement that is fixed on the carrier element, wherein the thread arrangement comprises a plurality of thread sections, each thread sections having a plurality of thread loops.

The invention further relates to a vehicle seat with at least one cushion and a heating device for heating a user contact surface of the cushion.

### BACKGROUND

The demands users impose on the heating devices of their vehicle seats are constantly increasing. Apart from that, it is necessary that such heating devices can be manufactured cost-effectively and may be operated in an energy-efficient manner. On the one hand, modern vehicle seats should be able to be heated up quickly and, on the other hand, the heating-up shall take place comfortably for the user, while at the same time ensuring high operational reliability. Furthermore, the generation of electromagnetic fields shall be avoided and a high reliability and a long operational lifetime shall be guaranteed by the manufacturer. Heating devices should be able to be operated with different power densities so that they can be used in a broad range of applications.

The heating devices known in the prior art can only partially meet the aforementioned requirements. The object of the invention is therefore to provide a heating device which is improved with respect to at least one of the properties mentioned.

### SUMMARY

The object is achieved by a heating device of the type mentioned at the outset, wherein a plurality of thread sections of the thread arrangement of the heating device according to the invention are arranged side by side in an overlapping manner such that the thread sections of the thread arrangement being arranged side by side in an overlapping manner cross each other several times.

The invention makes use of the fact that the reliability and the operational lifetime of such a heating device can be improved by a fail-safe laying pattern of the threads used. Due to the thread sections that are arranged side by side in an overlapping manner and that cross each other several times a thread breakage or another damage to a thread no longer leads to a large-scale or complete failure of the heating device. In case of failure, redundancy can be used due to the multiple crossing points of the thread sections that are arranged side by side in an overlapping manner. The redundancy basically prevents functional impairment in the event of damage to a thread. The thread sections that are arranged side by side in an overlapping manner extend at least sectionally non-parallel and/or asymmetrically. The thread sections that are arranged side by side in an overlapping manner can be mirrored to one another and/or can have an inverse pathway at least in a certain area. The thread loops of the thread sections can, for example, be thread windings of at least 90 degrees, in particular of at least 135 degrees. In a preferred embodiment, the thread loops of the thread sections are 180-degree thread windings.

In a preferred embodiment of the heating device according to the invention, the thread sections of the thread arrangement that are arranged side by side in an overlapping manner touch each other within a plurality of crossing areas. The crossing areas are preferably located between the thread loops of the thread sections. Alternatively, or additionally, crossing areas can be present in the pathway of a thread loop. Due to the thread contacts in the crossing areas multiple contacting of the thread sections can be realized, so that the thread sections are divided into a plurality of thread segments, each thread segment preferably extending between two points of contact. This leads to the advantage that only a thread segment failure occurs when a thread gets damaged. A large-scale failure of the heater due to one damaged thread section or due to a few damaged thread sections is effectively avoided.

In another preferred embodiment of the heating device according to the invention, the thread sections of the thread arrangement that are arranged side by side in an overlapping manner touch each other along thread contact paths within the crossing areas. In the area of a thread contact path, the mutually touching thread sections preferably extend parallel to each another. The thread contact paths are positioned preferably between the thread loops.

Furthermore, a heating device according to the invention is preferred, wherein a plurality of the thread sections of the thread arrangement that are arranged side by side in an overlapping manner are carbon heating thread sections of a carbon heating thread or of a plurality of carbon heating threads, which form a carbon heating thread field. Preferably, the carbon heating sections are designed to generate heat when an electrical current flows through the carbon heating thread sections. The carbon heating thread sections preferably extend along a heating path or within a heating zone of the heater. The carbon heating threads preferably comprise one or more carbon fibers. Carbon fibers are a robust and inexpensive resistance heating material. Carbon fibers are also durable and hard-wearing. Due to the high thread density, a particularly high area-specific heating output can be realized in the area of a carbon heating thread field. The carbon heating threads can comprise, for example, 200 tex or 67 tex yarn filaments. The carbon heating threads can comprise multiple, for example two, yarn filaments for reducing the electrical resistance.

In another embodiment of the heating device according to the invention, a plurality of the thread sections of the thread arrangement that are arranged side by side in an overlapping manner are metallic contact thread sections of a metallic contact thread or of a plurality of metallic contact threads, which form a contact thread field for carbon heating threads. A contact thread field serves as an electrode for one or multiple carbon heating threads of the heating device. Therefore, it is preferred that the heating device has at least two contact thread fields, which serve as electrodes for one or multiple carbon heating threads of the heating device. The one or multiple contact thread fields can have a rectangular, square or round basic shape. In addition to their electrode function, the contact thread sections can also have a heating function, since they also generate heat during operation. The contact threads may be heating strands with a plurality of metallic filaments. Due to the high thread density in the area of a contact thread field, a particularly high surface-specific heating output can be realized in these surface sections. Preferably, the one or multiple contact thread fields each have a plurality of thread sections that are arranged side by side in an overlapping manner and cross each other several times, so that there are a large number of contact points between the overlapping thread sections. This also leads to increased contact security in the event of thread damage or a thread breakage, since the contact points ensure an electrically conductive connection basically over the entire contact thread field even after a thread breakage.

In a further preferred embodiment of the heating device according to the invention, the plurality of contact thread sections of a contact thread field that are arranged side by side in an overlapping manner each touch one or multiple carbon heating threads several times. The one or multiple carbon heating threads are thus contacted via the contact thread field serving as an electrode. The main direction of extension of the contact thread sections of a contact thread field preferably extends transversely to the main direction of extension of the one or multiple contacted carbon heating thread sections. The multiple contacts between the one or multiple carbon heating threads and the contact thread sections of the contact thread field leads to a reduced contact resistance between the contact threads and the carbon heating threads.

In addition, a heating device according to the invention is advantageous, wherein the contact thread field is at least partially sealed. In particular, the contact thread field is partially or completely sealed with an adhesive. If the heating device has a plurality of contact thread fields, preferably each contact thread field is sealed with a sealing assigned to the respective contact thread field, in particular with adhesive. The one or multiple contact thread fields can be covered with the sealing material. The sealing material is preferably applied in a liquid state and dries out after application on the one or multiple contact thread fields. If the sealing material is adhesive, the use of a hot melt adhesive is preferred. The sealing protects the one or multiple contact thread fields against corrosion and external stress. The sealing can lead to a moisture-tight and/or gas-tight seal of the one or multiple contact thread fields.

In a further embodiment, the heating device according to the invention has a plurality of contact thread fields arranged at a distance from one another, wherein one or multiple carbon heating threads that are contacted with the contact thread fields extend between these contact thread fields. The carbon heating threads contacted with the contact thread fields and extending between the contact thread fields may have a substantially straight-line main direction of extension and extend locally between the contact thread fields with which they are contacted. The carbon heating threads can extend in a meandering and/or loop-like manner along the main direction of extension and/or form one or multiple carbon heating thread fields. Alternatively, the carbon heating threads contacted with the contact thread fields and running between the contact thread fields can have an at least partially circumferential or arcuate main direction of extension, so that the carbon heating threads also pass through surface areas that are not locally between the contact thread fields. For example, the carbon heating threads run along an edge region of the carrier element and/or run at least in sections around a central segment of the carrier element.

In another preferred embodiment of the heating device according to the invention multiple contact thread fields are positioned at spaced apart points on the carrier element. In particular, the heating device has exactly or only two, three, four, five, six, seven, eight, nine, ten or more than ten contact thread fields, which are positioned at spaced apart points on the carrier element.

In another preferred embodiment of the heating device according to the invention, a plurality of contact thread sections coming from a contact thread field are collectively crimped. The crimp is preferably connected via an electrically conductive connection conductor with an electrical power supply device. The collective crimping of multiple contact thread sections leads to increased corrosion resistance and reduces manufacturing costs. The crimping point can be sealed, preferably with adhesive.

In another preferred embodiment of the heating device according to the invention, one or multiple, in particular two, three or four, first contact thread fields are arranged in a first region of the carrier element and one or multiple, in particular two, three or four, second contact thread fields are arranged in a second region of the carrier element. Preferably, each first contact thread field is connected to a second contact thread field via one or multiple carbon heating thread sections and/or one or multiple carbon heating thread fields. The first contact thread fields are preferably connected in series via contact thread sections. The number of contact thread sections between the first contact thread fields can vary. In particular, the number of contact thread sections between the first contact thread fields decreases as the row position progresses. Preferably, the second contact thread fields are connected in series via contact thread sections. The number of contact thread sections between the second contact thread fields can vary. In particular, the number of contact thread sections between the second contact thread fields decreases as the row position progresses.

Also, a heating device according to the invention is preferred, in which the carbon heating threads comprising the carbon heating thread fields extend around the carrier element by a range of at least 90 degrees, preferably by a range of 180 degrees. A group of carbon heating threads preferably extends along an outer surface section of the carrier element. Preferably, a group of carbon heating threads extends along an inner surface section of the carrier element.

In another embodiment of the heating device according to the invention, a plurality of carbon heating thread sections coming from a carbon heating thread field are collectively crimped. The crimp is preferably connected via an electrically conductive connection conductor with an electrical power supply device. The collective crimping of several carbon heating thread sections leads to increased corrosion resistance and lowers the manufacturing costs. The crimping point can be sealed, preferably with adhesive.

In another preferred embodiment of the heating device according to the invention, the carbon heating thread sections and/or the contact thread sections are sewn to the carrier element themselves. Alternatively or additionally, the carbon heating thread sections and/or the contact thread sections are sewn to the carrier element by means of a separate fixing thread. The carbon heating thread sections can also be fixed to the carrier element by means of contact thread sections sewn to the carrier element. In this case, the carbon heating thread sections can also be sewn to the carrier element themselves. Alternatively, the contact thread sections can also be fixed to the carrier element by means of carbon heating thread sections sewn to the carrier element. In this case, the carbon heating thread sections can also be sewn to the carrier element themselves. The spacing of the holes in the stitching is preferably less than 3 mm, in particular less than 2 mm, particularly preferably about 1 mm. In the region of the contact thread fields the contact resistance between the contact thread sections and the carbon heating threads is reduced.

In a preferred embodiment of the heating device according to the invention, the carrier element is a flat material layer, in particular a textile material layer. Due to the flat design of the carrier element, the carrier element can be fastened in the vicinity of a user contact surface of a cushion. The textile design of the carrier element makes it permeable to air and/or moisture. Alternatively, the carrier element can also be designed as a film. The carrier element is preferably tearresistant and/or has a plurality of holes and/or recesses. Through the holes or recesses a considerable reduction in material and/or weight can be achieved.

The object of the invention is also achieved by a vehicle seat of the type mentioned at the outset, wherein the heating device of the vehicle seat according to the invention is designed in accordance with one of the embodiments described above. With regard to the advantages and modifications of the vehicle seat according to the invention, reference is made to the advantages and modifications of the heating device according to the invention.

The cushion of the vehicle seat can be a buttocks cushion of the seat surface of the vehicle seat or a back cushion of the backrest of the vehicle seat.

### BRIEF DESCRIPTION OF THE DRAWINGS

Preferred embodiments of the invention are explained and described in more detail below with reference to the accompanying drawings. Showing:

FIG. 1 is an embodiment of the heating device according to the invention in a schematic representation in a plan view;

FIG. 2 is a first thread section of the thread arrangement of the heating device shown in FIG. 1;

FIG. 3 is a second thread section of the thread arrangement of the heating device shown in FIG. 1;

FIG. 4 is another embodiment of the heating device according to the invention in a schematic representation;

FIG. 5 is another embodiment of the heating device according to the invention in a schematic representation;

FIG. 6 is another embodiment of the heating device according to the invention in a schematic representation;

FIG. 7 is another embodiment of the heating device according to the invention in a schematic representation;

FIG. 8 is another embodiment of the heating device according to the invention in a schematic representation;

FIG. 9 is another embodiment of the heating device according to the invention in a schematic representation;

FIG. 10 is a cushion of a vehicle seat according to the invention in a schematic representation;

FIG. 11 is another cushion of a vehicle seat according to the invention in a schematic representation; and

FIG. 12 is another cushion of a vehicle seat according to the invention in a schematic representation.

### DETAILED DESCRIPTION

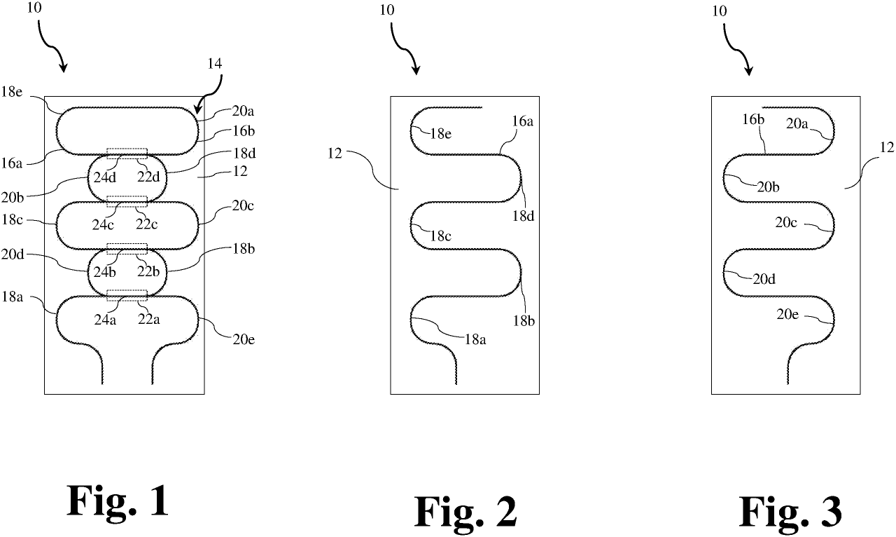

FIGS. 1 to 3 show a heating device 10 for a vehicle seat. The heating device 10 can be attached to a cushion of the vehicle seat or can be integrated into a cushion of a vehicle seat.

The heating device 10 comprises a carrier element 12. The carrier element 12 is a flat textile material layer. By designing the carrier layer 12 as a flat material layer, the carrier element 12 can be attached in the vicinity of a user contact surface of the cushion. The textile design of the carrier element 12 ensures air and moisture permeability, which is perceived by the user of the vehicle seat as comfort-enhancing.

An electrically conductive thread assembly 14 is fixed on the carrier element 12. The thread arrangement 14 has a plurality, namely two, thread sections 16a, 16b which are sewn to the carrier element 12. The thread sections 16a, 16b each have a plurality of thread loops 18a-18e, 20a-20e. The thread loops 18a-18e, 20a-20e are thread windings extending over 180 degrees.

The thread sections 18a, 18b of the thread arrangement 14 are arranged side by side in an overlapping manner such that the thread sections 16a, 16b that are arranged side by side in an overlapping manner cross each other several times.

The thread sections 18a, 18b of the thread arrangement 14 that are arranged side by side in an overlapping manner touch each other in a plurality of crossing areas 22a-22d. The crossing areas 22a-22d are located between the thread loops 18a-18e, 20a-20e of the thread sections 16a, 16b. In the present case, the thread sections 18a, 18b of the thread arrangement 14 that are arranged side by side in an overlapping manner touch each other along a thread contact path within the crossing areas 22a-22d. The thread loops 18a-18e of the thread section 16a and the thread loops 20a-20e of the thread section 16b are arranged opposite each another and have an opposite orientation and a mirrored pathway. Consequently, the thread sections 16a, 16b that are arranged side by side in an overlapping manner extend sectionally non-parallel to each other. The seam pattern, which is defined by the thread sections 16a, 16b, can be produced inexpensively and allows an energy-efficient provision of a high heating power. The plurality of crossing points also ensures increased operational and functional reliability, since a thread breakage or a thread damage does not lead to the failure of the entire heating device 10.

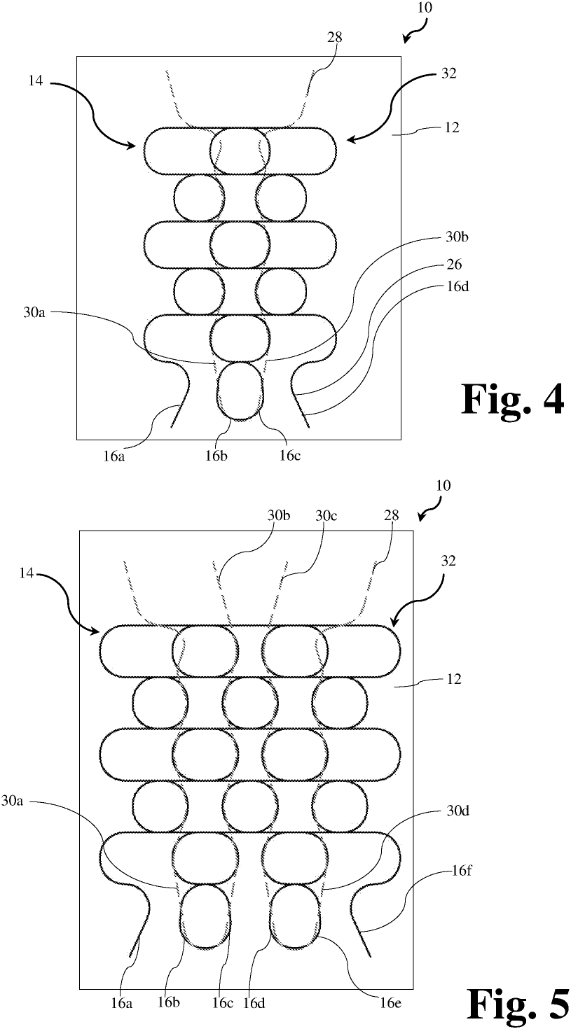

FIG. 4 shows a heating device 10 with a metallic contact thread 26 and a carbon heating thread 28. The metallic contact thread 26 is a stranded conductor with a plurality of metallic filaments. The metallic contact thread 26 comprises a plurality of metallic contact thread sections 16a-16d that are arranged side by side in an overlapping manner, wherein the contact thread sections 16a-16d define a contact thread field 32. The carbon heating thread 28 is fastened to the carrier element 12 and electrically contacted by means of the contact thread field 32. The contact thread field 32 thus serves as an electrode for the carbon heating thread 28.

The contact thread sections 16a-16d are sewn on the carrier element 12 so that the carbon heating thread 28 is fixed by a seam on the carrier element 12. Further, the contact thread sections 16a-16d each have a plurality of thread loops and intersect each other several times, so that there are multiple points of contact between the individual contact thread sections 16a-16d. Furthermore, the plurality of contact thread sections 16a-16d of the contact thread field 32 that are arranged side by side in an overlapping manner touch the two substantially mutually parallel carbon heating thread sections 30a, 30b of the carbon heating thread 28 several times. The contact resistance between the contact thread 26 and the carbon heating thread 28 is thus reduced. Due to the high thread density in the area of the contact thread field 32, a particularly high area-specific heating output is realized locally in this area.

FIG. 5 shows a heating device 10, wherein the contact thread 26 has a total of six contact thread sections 16a-16f that are arranged side by side in an overlapping manner. The contact thread sections 16a-16f again each have a plurality of thread loops. The thread sections 16a-16f are arranged such that they overlap one another in a way that they intersect each other several times. The contact thread sections 16a-16f define a contact thread field 32, which is sewn to the carrier element 12. A carbon heating thread 28 is fixed on the carrier element 12 by means of the sewn contact thread 26. The carbon heating thread 28 has four carbon heating thread sections 30a-30d which extend basically parallel to one another. The plurality of contact thread sections 16a-16f of the contact thread field 32, which are arranged side by side in an overlapping manner, touch the plurality of carbon heating thread sections 30a-30d several times.

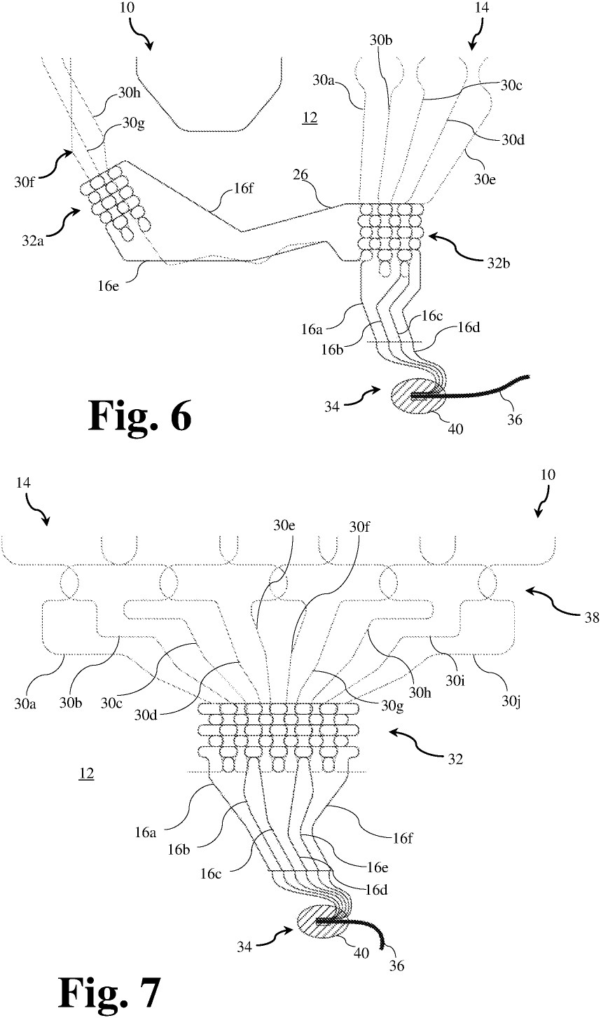

FIG. 6 shows a heating device 10 with two contact thread fields 32a, 32b that are electrically conductively connected to one another. The contact thread fields 32a, 32b are connected to one another via the contact thread sections 16e, 16f. The contact thread field 32a serves to contact the carbon heating thread sections 30f-30h. The contact thread field 32b serves to contact the carbon heating thread sections 30a-30e. The contact thread sections 16a-16d coming from the contact thread field 32b are collectively crimped at the crimping point 34. The crimping point 34 is protected against corrosion and connected by a sealing 40 and connected with an electrical power supply device by means of an electrically conductive connection conductor 36.

FIG. 7 shows a heating device 10 with a contact thread field 32. The contact thread sections 16a-16f coming from the contact thread field 32 are collectively crimped at the crimping point 34.

The contact thread field 32 serves for electrical contacting of carbon heating thread sections 30a-30j. In this case, the carbon heating thread sections 30a-30j are also arranged side by side in an overlapping manner and define a carbon heating thread field 38. The carbon heating thread sections 30a-30j are configured to generate heat. The carbon heating thread field 38 is located within heating zone of the carrier element 12. The carbon heating thread sections 30a-30j comprise, for example, a plurality of carbon fibers. Due to the high thread density in the area of the carbon heating thread field 38, a particularly high area-specific heating output can be realized here. The carbon heating thread sections 30a-30j may be part of a carbon heating thread 28 or of a plurality of carbon heating threads. The one or multiple carbon heating threads can comprise, for example, 67 tex yarn filaments or 200 tex yarn filaments.

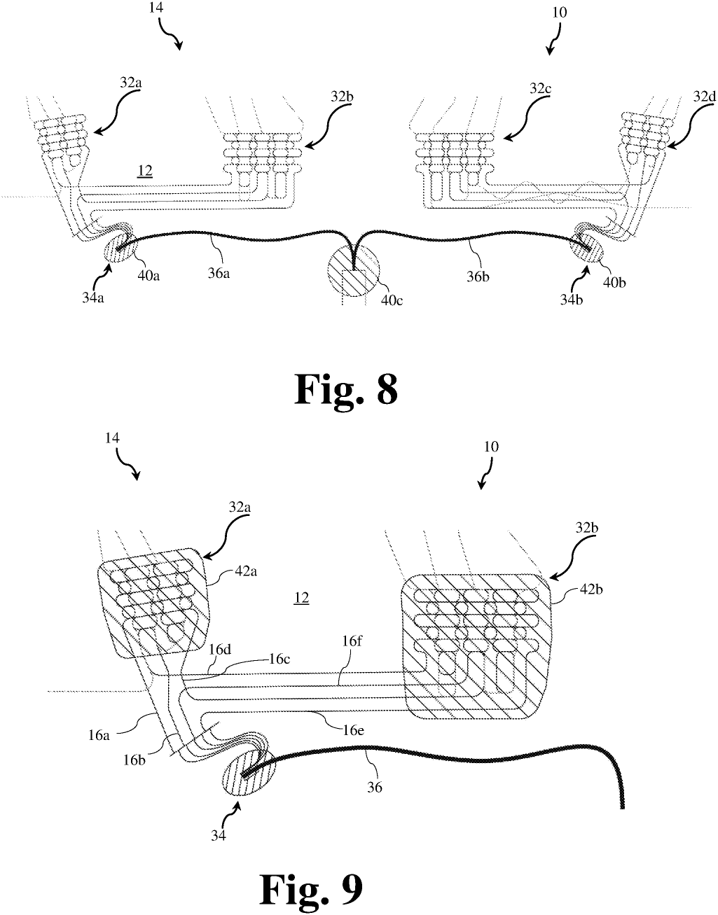

FIG. 8 shows a heating device 10 with a left heating wing and a right heating wing. The contact thread sections that lead to the contact thread fields 32a, 32b are crimped at the crimping point 34a. The crimping point 34a is sealed by a sealing 40a and connected to a connecting conductor 36a. The carbon heating threads of the left heating wing are contacted via the contact thread fields 32a, 32b. The contact thread sections that lead to the contact thread fields 32c, 32d are crimped at the crimping point 34b. The crimping point 34b is sealed by a sealing 40b and connected to a connecting conductor 36b. The carbon heating threads of the right heating wing are contacted via the contact thread fields 32c, 32d.

FIG. 9 shows a heating device 10, wherein the contact thread fields 32a, 32b are sealed with an adhesive sealing 42a, 42b. For sealing a hot-melt adhesive was applied to the contact thread fields 32a, 32b in the flowable state. After the hot-melt adhesive has dried, the sealings 42a, 42b provide protection for the contact thread fields 32a, 32b against corrosion and external stress. The sealings 42, 42b seal the contact thread fields 32a, 32b in a moisture-tight and gas-tight manner.

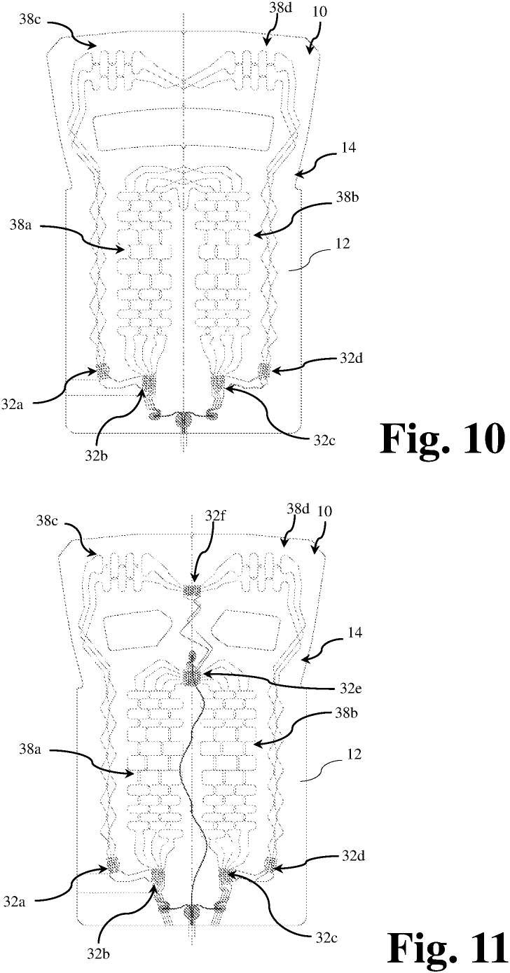

FIG. 10 shows a cushion of a backrest of a vehicle seat with a heating device 10. In a lower region, the heating device 10 has four contact thread fields 32a-32d, which are positioned at specific points on a textile carrier element 12.

The carbon heating threads contacted with the contact thread fields 32a, 32d extend between the contact thread fields 32a, 32d, wherein the contact thread fields 32a, 32d are spaced apart from one another. The carbon heating threads contacted with the contact thread fields 32a, 32d form two carbon heating thread fields 38c, 38d in an upper region of the carrier element 12. The carbon heating threads extending between the contact thread fields 32a, 32d run along the lateral outer regions and an upper outer region of the carrier element 12 and thus not along the direct connection axis between the contact thread fields 32a, 32d.

The carbon heating threads contacted with the contact thread fields 32b, 32c extend between the contact thread fields 32b, 32c, wherein the contact thread fields 32b, 32c are spaced apart from one another. The carbon heating threads contacted with the contact thread fields 32b, 32c form two carbon heating thread fields 38a, 38b in a central region of the carrier element 12. The carbon heating threads extending between the contact thread fields 32b, 32c run along an inner region of the carrier element and are surrounded by the carbon heating threads contacted with the contact thread fields 32a, 32d. The carbon heating threads extending between the contact thread fields 32b, 32c also do not run along the direct connection axis between the contact thread fields 32b, 32c.

The carbon heating threads running in the outer region of the carrier element 12 and the carbon heating threads running in the inner region of the carrier element 12 of the heating device 10 shown in FIG. 11 are electrically conductively connected to one another via the contact thread fields 32e, 32f. The heating device 10 thus has a total of six contact thread fields 32a-32f positioned at specific points on the carrier element 12. Due to the additional contacting of the carbon heating thread sections, the heating power of the heating device 10 is increased and, in addition, an increased reliability is realized.

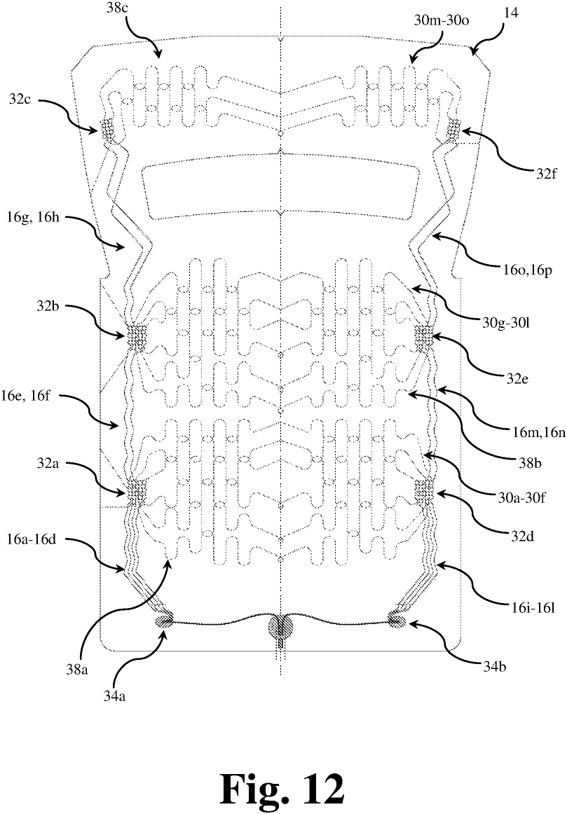

The heating device 10 shown in FIG. 12 has three contact thread fields 32a-32c arranged on the left side of the carrier element 12 and three contact thread fields 32d-32f arranged on the right side of the carrier element 12. A plurality of carbon heating thread sections 30a-30f, which form a carbon heating thread field 38a, extend between the contact thread fields 32a, 32d, wherein the contact thread fields 32a, 32d are spaced apart from one another. The contact thread field 32a is connected to the crimping point 34a via the four contact thread sections 16a-16d. The contact thread field 32d is connected to the crimping point 34d via the four contact thread sections 16i-16l.

The contact thread field 32b is connected to the contact thread field 32a via the two contact thread sections 16e, 16f. The contact thread field 32e is connected to the contact thread field 32d via the two contact thread sections 16m, 16n. A plurality of carbon heating thread sections 30g-30l, which form a carbon heating thread field 38b, extend between the contact thread fields 32b, 32e which are spaced apart from one another.

The contact thread field 32b is connected to the contact thread field 32c via the contact thread sections 16g, 16h. The contact thread field 32e is connected to the contact thread field 32f via the two contact thread sections 16o, 16p. A plurality of carbon heating thread sections 30m-30o, which form a carbon heating thread field 38c, extend between the contact thread fields 32c, 32f, which are spaced apart from one another.

### LIST OF REFERENCES

10 heating device
12 carrier element
14 thread arrangement
16a-16p thread sections
18a-18e thread loops
20a-20e thread loops
22a-22d crossing areas
24a-24d thread contact paths
26 contact thread
28 carbon heating thread
30a-30o thread sections
32, 32a-32f contact thread fields
34, 34a, 34b crimpings
36, 36a, 36b connecting conductors
38, 38a-38d carbon heating thread fields
40, 40a-40c sealings
42a, 42b sealings

1. A heating device for a vehicle seat, the heating device comprising:
a carrier element; and
an electrically conductive thread arrangement that is fixed on the carrier element;
wherein the electrically conductive thread arrangement comprises a plurality of thread sections, each of the plurality of thread sections has a plurality of thread loops; and
wherein the plurality of thread sections are arranged side by side in an overlapping manner such that the plurality of thread sections cross each other several times.

2. The heating device according to claim 1, wherein the plurality of thread sections touch each other in a plurality of crossing areas, the plurality of crossing areas are located between the plurality of thread loops.

3. The heating device according to claim 2, wherein the plurality of thread sections touch each other along thread contact paths within the plurality of crossing areas.

4. The heating device according to claim 1 ,
wherein the plurality of thread sections are carbon heating thread sections of a carbon heating thread or of a plurality of carbon heating threads, which form a carbon heating thread field.

5. The heating device according to claim 1 ,
wherein the plurality of thread sections are metallic contact thread sections of a metallic contact thread or of a plurality of metallic contact threads, which form a contact thread field for carbon heating threads.

6. The heating device according to claim 5, wherein
the metallic contact thread sections touch one or multiple carbon heating threads several times.

7. The heating device according to claim 5, wherein,
the contact thread field is sealed at least sectionally with adhesive.

8. The heating device according to claim 5, wherein the
contact thread fields are arranged at a distance from one another, wherein the one or multiple carbon heating threads that are contacted with the contact thread fields extend between the contact thread fields .

9. The heating device according to claim 5, wherein the
of contact thread fields are positioned at spaced apart points on the carrier element.

10. The heating device according to claim 5, wherein the metallic
contact thread sections coming from the contact thread field are collectively crimped.

11. The heating device according to claim 5, wherein
one or morefirst contact thread fields are arranged in a first region of the carrier element and one or more second contact thread fields are arranged in a second region of the carrier element, and each of the first contact thread field is connected to the second contact thread field via one or more of the carbon heating thread fields.

12. The heating device according to claim 11, wherein
the carbon heating threads that comprise the one or more of the carbon heating thread fields extend around the carrier element by a range of at least 90 degrees.

13. The heating device according to claim 4, wherein the
plurality of carbon heating thread sections coming from a carbon heating thread field are collectively crimped.

14. The heating device according to claim 4, wherein
the carbon heating thread sections and/or the metallic contact thread sections are sewn to the carrier element and/or are sewn to the carrier element by means of a separate fixing thread.

15. The heating device according to claim 1, wherein
the carrier element is a flat material layer or a textile material layer.

16. A vehicle seat, comprising:
at least one cushion, and
the heating device according to claim 1 .
